(19) United States
(12) Patent Application Publication
(10) Pub. No.: US 2011/0032630 A1
(43) Pub. Date: Feb. 10, 2011

(54) MULTI-MODE LOOP ADAPTATION SCHEME FOR HIGH-DENSITY DATA RECORDING CHANNEL

(75) Inventors: Jaewook Lee, Irvine, CA (US); Sizhen Yang, Irvine, CA (US); Umang Mehta, Irvine, CA (US); Jerry Hodges, Riverside, CA (US); Marc Feller, Long Beach, CA (US); Turguy Goker, Solana Beach, CA (US)

Correspondence Address: James P. Broder;Roeder & Broder LLP, 9915 Mira Mesa Blvd. Suite 300, San Diego, CA, 92131, US

(73) Assignee: QUANTUM CORPORATION

(21) Appl. No.: 12/536,435

(22) Filed: Aug. 5, 2009

(51) Int. Cl. G11B 20/20

(52) U.S. Cl. 360/26; G9B/20.06

(57) ABSTRACT

A circuit for a high-density data recording channel includes a first data detector, a second data detector, one or more multiplexers and a sequence identifier. The first data detector generates a first data detector output, and the second data detector generates a second data detector output. The multiplexers change between a first mode and a second mode to alternately receive the first data detector output and the second data detector output. The sequence identifier receives a data sequence including at least one of a first data sequence, such as VFO data, and a second data sequence, such as random data. The second data sequence includes a greater number of signal levels than the first data sequence. The sequence identifier changes the multiplexers between the first mode and the second mode based on whether the data sequence is the first data sequence or the second data sequence. The data sequence includes a plurality of timing stages. The sequence detector can at least partially control a loop bandwidth of the circuit based on the timing stage of the data sequence.

### BACKGROUND

Decisions for timing phase error calculations are typically based on a channel symbol detector or sequence detector. In general, the performance of the detector is based on the delay of the decision. The longer the decision delay, the better the decision quality. Short decision delays generally lead to a decreased decision quality. When a timing recovery loop operates in a noisy channel condition, the decision error can cause timing recovery failure as a result of insufficient time or delay to make a quality decision. To prevent this type of failure, a detector with a longer decision delay can be used. However, this delay adds to the entire latency of the timing loop and, consequently, exclusively using this longer decision delay can be undesirable. Furthermore, the latency of a timing recovery loop directly affects its tracking capability to timing phase variation. A timing recovery loop with a long decision delay detector can have a more limited tracking capability to timing phase variation.

Conventional slicer-based loop adaptations have the merit of small loop latency. However, these types of adaptations can cause a greater frequency of decision errors, particularly in high-density recording channels, such as an “EPR4” channel. These decision errors can be caused by numerous signal levels that are present in the high density recording channel models. The EPR4 channel model has five levels with random data (also sometimes referred to as “user data”), and three levels with variable frequency oscillator (“VFO”) data. In contrast, the low density recording channel model, such as a “PR4” channel model, has three levels with random data and two levels with VFO data.

A Viterbi detector can work relatively well even in the high density recording channels. However, use of the Viterbi detector can increase the loop latency by at least 10 clock cycles. In a circuit implementation, the loop latency increase will be relatively large due to additional pipeline delays. The increased loop latency can cause relatively slow loop responses and/or loop divergences. In addition, an issue of meta-stability also arises with repeating patterns such as VFO data in high density recording channel models. As used herein, meta-stability occurs when more stable points are present other than the desired zero-phase. Thus, timing recovery loops can lock at the meta-stable phase (also referred to as a “false lock”) instead of the zero-phase. False lock is problematic because it results in an increase in bit errors in the read channel system.

Previous conventional channel architectures have been implemented, but have had various drawbacks. For example, a three-step approach has been utilized which involves using three different types of equalizers. In the first step, a fixed finite impulse response (Fixed FIR) filter converts a received waveform into a simple PR4 channel model. At a second step, an adaptive FIR (AFIR) filter equalizes the rough PR4 waveform into a fine PR4 waveform using a feedback loop. At a third step, a noise-whitening filter changes the PR4 waveform into other higher channel waveforms, such as EPR4, EEPR4 or 821 channel waveforms. However, these multiple equalizations can result in excessive noise boosting. Further, including three different types of equalizers (Fixed FIR, AFIR, and the noise-whitening filters) can add substantial expense and complexity to the overall system, which can be cost-prohibitive.

### SUMMARY

The present invention is directed toward a circuit for a high-density data recording channel. In one embodiment, the circuit includes a first data detector, a second data detector, a first multiplexer and a sequence identifier. The first data detector generates a first data detector output, and the second data detector generates a second data detector output. The first multiplexer changes between a first mode and a second mode to alternately receive the first data detector output and the second data detector output. In certain embodiments, the sequence identifier receives a data sequence including at least one of a first data sequence and a second data sequence. In various embodiments, the second data sequence includes a greater number of signal levels than the first data sequence. The sequence identifier changes the first multiplexer between the first mode and the second mode based on whether the data sequence is the first data sequence or the second data sequence.

In another embodiment, the first data sequence includes variable frequency oscillator data. In one embodiment, the first data sequence can includes three signal levels. Further, the second data sequence can includes random data which can have five signal levels. The first data detector can include a slicer, such as a 3-level slicer. In one embodiment, the second data detector includes a Viterbi detector. In another embodiment, the circuit includes an automatic gain control loop and/or a phase-locked loop. In one embodiment, an output of the first multiplexer proceeds to the automatic gain control loop and/or an output of the second multiplexer proceeds to the phase-locked loop. In another embodiment, the circuit can also include a second multiplexer that changes between a first mode and a second mode to alternately receive the first data detector output and the second data detector output. In one embodiment, the data sequence includes a plurality of timing stages. In this embodiment, the sequence detector can at least partially control a loop bandwidth of the circuit based on the timing stage of the data sequence.

The present invention is also directed toward various methods for determining the binary sequence of a sampled digital waveform in a high density recording channel.

### BRIEF DESCRIPTION OF THE DRAWINGS

The invention, together with further advantages thereof, may best be understood by reference to the following description taken in conjunction with the accompanying drawings, taken in conjunction with the accompanying description, in which similar reference characters refer to similar parts, and in which:

FIG. 1 is a perspective view of one embodiment of a media drive having features of the present invention, and a media cartridge partially inserted within the media drive;

FIG. 2 is an illustration of signal levels in PR4 and EPR4 channel models for both VFO data and random data;

FIG. 3 is a block diagram illustrating one embodiment of a multi-mode read channel architecture that is included in the media drive assembly in FIG. 1;

FIG. 4 is an illustration of simulation results for AFIR input, AFIR output, signal error, phase error and Viterbi Decision for VFO data and random data using the multi-mode read channel architecture described relative to FIG. 3; and

FIG. 5 is a flow chart outlining one embodiment of a method for increasing performance of a high-density recording channel.

### DESCRIPTION

Embodiments of the present invention are described herein in the context of a system and method for a multi-mode loop adaptation scheme for a high-density data recording channel which can be used with various types of media drives and media drive systems. The present invention is particularly suited toward a process that facilitates more accurately and efficiently determining the binary sequence for a sampled digital waveform. Although the specific media drive illustrated and described herein is a tape drive, it is recognized that the present invention can be utilized with other types of media drives, including optical disk drives, virtual tape drives, disk drives, etc. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

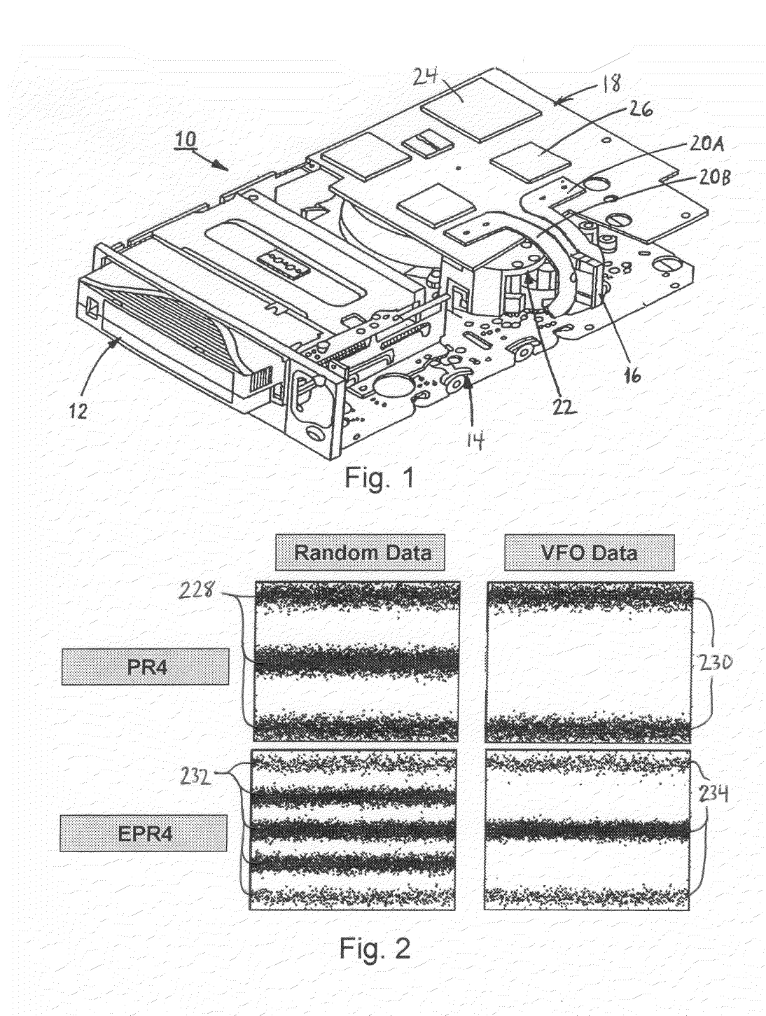

FIG. 1 depicts a perspective view of one embodiment of a media drive 10 (also sometimes referred to herein as a “drive”) constructed in accordance with embodiments of the present invention, and a media cartridge 12 (sometimes referred to herein as a “cartridge”) inserted within the drive 10. A housing for the drive 10, such as the top cover, is omitted from FIG. 1 for clarity. As one non-exclusive example, the media drive 10 can be a tape drive.

The cartridge 12, such as an LTO tape cartridge as one non-exclusive example, is insertable at one end of the tape drive 10. The cartridge 12 includes a storage tape (not shown) that stores data. The drive 10 also includes a drive base plate 14, a read/write head 16 (also sometimes referred to herein as a “head”), a printed circuit board 18, one or more flexible printed circuits 20A, 20B, and an actuator assembly 22. The head 16 is positioned relative to the storage tape by the actuator assembly 22. In one embodiment, the printed circuit board 18 can include various circuits including a controller 24 and a read/write channel 26 that are each directly and/or indirectly electrically coupled to the head 16. Alternatively, the controller 24 and/or the read/write channel 26 can be positioned remotely from the printed circuit board 18, but can still maintain electrical communication with the head 16 and/or the printed circuit board 18. The flexible printed circuits 20A, 20B, electrically couple the actuator assembly 22 and/or the head 16 to the printed circuit board 18.

FIG. 2 shows various illustrations of sampled digital signal levels for PR4 (low density recording channel) and EPR4 (high density recording channel) channel models, for both VFO data and random data. As used herein, VFO data is also referred to a “first data sequence”, and random data is also referred to as a “second data sequence”. As illustrated in FIG. 2, the PR4 channel model includes three signal levels 228 for random data, and two signal levels 230 for VFO data. In contrast, the EPR4 channel model includes five signal levels 232 for random data and three signal levels 234 for VFO data. In the embodiments described herein, the first data sequence can be any type of data that has fewer signal levels than the second data sequence (such as with VFO and random data, as described previously herein). Further, as used herein, the terms “digital signal”, “signal” and “digital waveform” are sometimes used interchangeably. As set forth in greater detail below, the multi-mode system disclosed herein targets the high density recording channel, which results in reduced hardware complexity and/or improvement of detection performance through decreased noise boosting.

Additionally, as explained in greater detail below, the multi-mode system provided herein addresses different types of data (random and VFO) in different ways, to increase the accuracy of the read channel. For example, as set forth below, for VFO data, the loop latency issue and/or the meta-stability issue described previously herein are reduced or avoided.

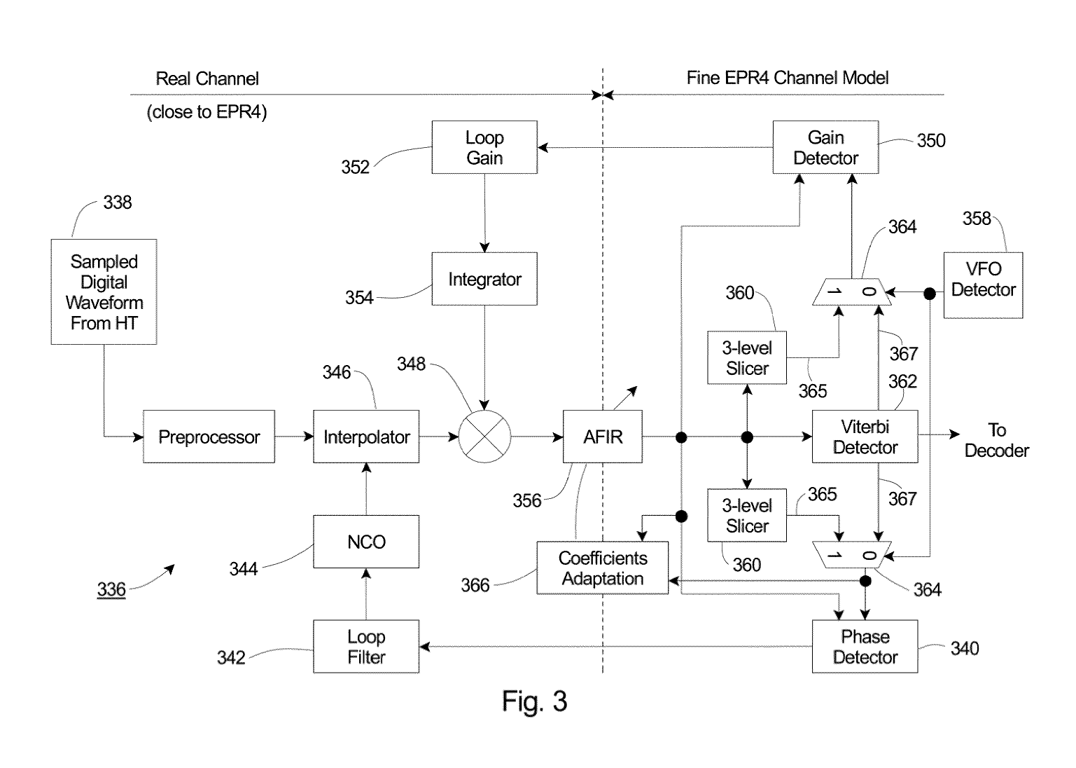

FIG. 3 is a block diagram illustrating one embodiment of a multi-mode read channel architecture 336 (also sometimes referred to herein as a “circuit” or “system”) that can be included in a media drive assembly, such as that illustrated in FIG. 1, as one non-exclusive example. In the embodiment illustrated in FIG. 3, a sampled digital waveform 338 is received into the circuit 336 from hyper-transport (indicated as “HT” in FIG. 3). In this embodiment, the read channel circuit 336 includes a phase-locked loop (“PLL”), an automatic gain control loop (“AGC”) and an adaptive finite impulse response filter adaptation (“AFIR filter adaptation”) loop. In one embodiment, the PLL can include one or more of a phase detector 340, a loop filter 342, a numerically controlled oscillator 344 (“NCO”), an interpolator 346, and a multiplier 348 used for gain control. The PLL can also include one or more steps that are included in the AFIR filter adaptation loop, which is set forth below.

In one embodiment, the AGC loop includes one or more of a gain detector 350, a loop gain 352, an integrator 354 and the multiplier 348. The AGC loop can also include one or more steps that are included in the AFIR filter adaptation loop, which is set forth below.

The AFIR filter adaptation loop permits adaptation of the real channel digital signal, which is close to an EPR4 channel model, to a fine EPR4 channel model. With this design, greater accuracy can be achieved. The specific design of the AFIR filter adaptation loop can be varied to suit the design requirements of the overall system. In accordance with the embodiment illustrated in FIG. 3, the AFIR filter adaptation loop can include an AFIR equalizer 356 (also sometimes referred to as an “adaptive filter”), a sequence identifier 358 (also sometimes referred to herein as a “VFO detector”), one or more first data detectors 360 (two first data detectors 360 are illustrated in FIG. 3), one or more second data detectors 362, one or more multiplexers 364 (two multiplexers 364 are illustrated in FIG. 3) and a coefficients adapter 366. In the embodiment illustrated in FIG. 3, one or more of the first data detectors 360 can include a 3-level slicer, and the second data detector 362 can include a Viterbi detector. Alternatively, the data detectors 360, 362, can include different types of data detectors than those illustrated in FIG. 3.

In one embodiment, the AFIR filter adaptation loop includes two 3-level slicers 360 and two multiplexers 364. In an alternative embodiment, the AFIR filter adaptation loop can include a single 3-level slicer 360 and a single multiplexer 364. In this type of AFIR filter adaptation loop, the output of the multiplexer 364 can go to both the phase detector 340 and the gain detector 350.

After processing of the digital waveform by the AFIR equalizer 356, the VFO detector 358 determines whether or not an output of the AFIR equalizer 356 is a VFO data signal. If the VFO detector 358 determines that the output of the AFIR equalizer 356 is a VFO data signal, the VFO detector 358 controls one or more of the multiplexers 364 accordingly. In one embodiment, if the VFO detector 358 determines that the output of the AFIR equalizer 356 is a VFO data signal, the VFO detector 358 can set the one or more multiplexers 364 to “1”, which would allow one more of the first data detectors 360 to be utilized to process the digital signal and generate a first data detector output 365. On the other hand, if the VFO detector 358 determines that the output of the AFIR equalizer 356 is not a VFO data signal, e.g., is a random data or user data signal, the VFO detector 358 can set the one or more multiplexers 364 to “0”. In the embodiment illustrated in FIG. 3, when the one or more multiplexers 364 are set to “0”, the second data detector 362 is utilized to process the digital signal and generate a second data detector output 367.

By incorporating a switching function to selectively utilize a particular data detector 360, 362 depending upon the type of data which is identified by the VFO detector 358, one or more advantages can be realized. For example, when VFO data is identified by the VFO detector 358, one or more first data detectors 360 (i.e. 3-level slicers) are utilized. By using 3-level slicers for VFO data rather than a Viterbi detector, for example, the loop latency issue and/or the meta-stability issue described previously herein are reduced or avoided. Conversely, when VFO data is not detected, by utilizing the second data detector 362 (i.e. the Viterbi detector), greater accuracy can be achieved. Additional advantages can include reduced hardware complexity by only including a single equalizer and/or detection performance improvement as a result of the decreased noise boosting by having fewer equalizers.

In another embodiment, the acquisition and tracking performance of the PLL and/or the AGC loop can be improved by altering the loop bandwidth according to the particular data sequence, i.e. random data, and various timing stages within the VFO data, as described below. For example, the VFO detector can first determine whether or not the data is VFO data. If the data is determined to be VFO data (VFO detection=1), the length of the data can be determined, and the data can be divided into “timing stages” (also sometimes referred to herein as “stages”) based upon the length of the data, i.e. “early stage” and “final stage” for purposes of setting the loop bandwidth. In one embodiment, a counter value is determined, which identifies the specific stage that of the VFO data.

To illustrate, if the length of the VFO data is 500, then early stage data can be approximately when 0<counter value<250, and final stage is when 250<counter value<500. In one embodiment, the VFO detector 358 can determine the counter value of the data at any point in time. Alternatively, another structure or circuit can determine the counter value of the VFO data and provide this counter value as necessary to determine the stage of the VFO data. In this example, the loop bandwidth for early stage VFO data can be set at a relatively large value to approach the correct loop operating point more quickly. In the final stage of VFO data, the loop bandwidth can be set to a smaller value to remove residual small errors in the loop. During random data, the loops can be run at the steady-state in the user data.

In an alternative embodiment, greater than two stages of VFO data can be identified. For example, the VFO data can be divided into three or more stages, with each stage having a specific loop bandwidth. In this embodiment, the loop bandwidth can decrease at the stages progress from the early stage to intermediate stages to the final stage. In one embodiment, the length of each stage can be substantially similar to one another. Alternatively, the length of one or more stages can differ from one or more of the remaining stages. In the embodiments described herein, the loop filter can be carefully controlled to achieve a seamless or near-seamless mode switching between the different loop bandwidths.

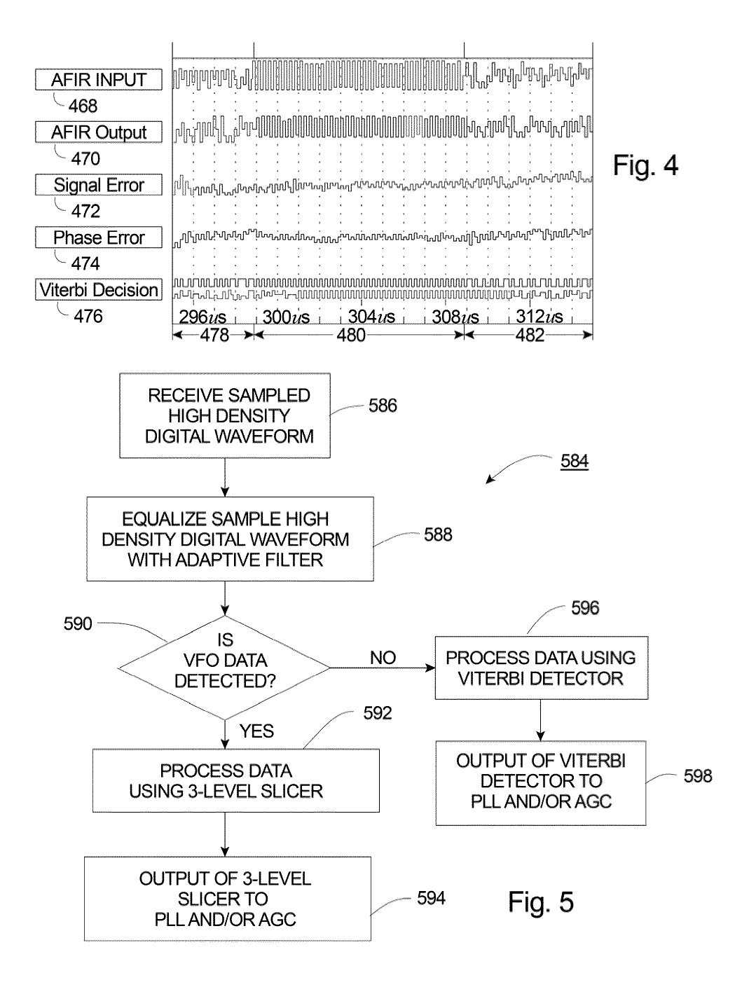

FIG. 4 is a simulation readout of AFIR input 468, AFIR output 470, signal error 472, phase error 474 and Viterbi decision 476 for a sampled digital high density waveform while utilizing one embodiment of the multi-mode read channel architecture shown and described herein. In this embodiment, the sampled digital high density waveform includes a first random data field 478, followed by VFO data field 480, then back to a second random data field 482.

In the VFO data field 480, the AFIR input 468 illustrates incoming VFO data which has a relatively consistent amplitude. This VFO data is then equalized by the AFIR filter to yield the AFIR output 470, which likewise has a more consistent amplitude in the VFO data field 480 than would be expected for single-mode read channel architecture. Additionally, the signal error 472 and phase error 474 have decreased fluctuations at the VFO data field 480, which is indicative of decreased loop latency and decreased meta-stability problems. Moreover, because the AFIR output 470 is more consistent at the VFO data field 480, the Viterbi decision 476 is similarly more consistent, which illustrates a greater accuracy of the Viterbi decision 476 in the VFO data field 480.

FIG. 5 is a flow chart outlining one embodiment of a method 584 including steps for increasing performance of a high-density recording channel. At step 586, a sampled high density digital waveform is received.

At step 588, the sampled high density digital waveform is equalized with an adaptive filter, such as an AFIR.

At step 590, the VFO detector determines whether the equalized sampled high density digital waveform is VFO data.

At step 592, if the equalized sampled high density digital waveform is VFO data, the data is processed with the first data detector, such as a 3-level slicer.

At step 594, the output of the 3-level slicer proceeds to the PLL or the AGC loop, as described above.

At step 596, if the equalized sampled high density digital waveform is not VFO data, the data is processed with the second data detector, such as the Viterbi detector.

At step 598, the output of the Viterbi detector proceeds to the PLL or the AGC loop, as described above, and eventually proceeds to a data decoder to determine the binary sequence of the sampled digital waveform.

It is recognized that one or more steps as illustrated and described in FIG. 5 can be omitted, or conversely, that one or more steps not illustrated in FIG. 5 can be added without deviating from the intent and/or purpose of the methods described herein.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A circuit for a high-density data recording channel, the circuit comprising:
a first data detector that generates a first data detector output;
a second data detector that is different than the first data detector, the second data detector being adapted to generate a second data detector output;
a first multiplexer that changes between a first mode and a second mode to alternately receive the first data detector output and the second data detector output; and
a sequence identifier that receives a data sequence including at least one of a first data sequence and a second data sequence, the second data sequence including a greater number of signal levels than the first data sequence, the sequence identifier changing the first multiplexer between the first mode and the second mode based on whether the data sequence is the first data sequence or the second data sequence.

2. The circuit of claim 1 wherein the first data sequence includes variable frequency oscillator data.

3. The circuit of claim 2 wherein the first data sequence includes three signal levels.

4. The circuit of claim 1 wherein the second data sequence includes random data.

5. The circuit of claim 4 wherein the second data sequence includes five signal levels.

6. The circuit of claim 1 wherein the first data detector includes a slicer.

7. The circuit of claim 6 wherein the slicer is a 3-level slicer.

8. The circuit of claim 1 wherein the second data detector includes a Viterbi detector.

9. The circuit of claim 1 further comprising an automatic gain control loop, and wherein an output of the first multiplexer proceeds to the automatic gain control loop.

10. The circuit of claim 1 further comprising a phase-locked loop, and wherein an output of the first multiplexer proceeds to the phase-locked loop.

11. The circuit of claim 10 further comprising a second multiplexer that changes between a first mode and a second mode to alternately receive the first data detector output and the second data detector output.

12. The circuit of claim 11 further comprising an automatic gain control loop, wherein an output of the second multiplexer proceeds to the automatic gain control loop.

13. The circuit of claim 1 wherein the data sequence includes a plurality of timing stages, and the sequence detector at least partially controls a loop bandwidth of the circuit based on the timing stage of the data sequence.

14. A method for determining the binary sequence of a sampled digital waveform in a high density recording channel, the method comprising the steps of:
receiving a data sequence with a sequence identifier of a circuit, the data sequence including at least one of a first data sequence and a second data sequence having a fewer number of signal levels than the first data sequence;
alternately receiving a first data detector output from a first data detector and a second data detector output from a second data detector with a first multiplexer of the circuit; and
changing the first multiplexer between a first mode and a second mode with the sequence identifier based on whether the data sequence is the first data sequence or the second data sequence.

15. The method of claim 14 wherein the first data sequence includes variable frequency oscillator data.

16. The method of claim 15 wherein the first data sequence includes three signal levels.

17. The method of claim 14 wherein the second data sequence includes random data.

18. The method of claim 17 wherein the second data sequence includes five signal levels.

19. The method of claim 14 wherein the first data detector includes a slicer.

20. The method of claim 19 wherein the slicer is a 3-level slicer.

21. The method of claim 14 wherein the second data detector includes a Viterbi detector.

22. The method of claim 14 further comprising the step of receiving an output of the first multiplexer with an automatic gain control loop.

23. The method of claim 14 further comprising the step of receiving an output of the first multiplexer with a phase-locked loop.

24. The method of claim 23 further comprising the step of changing the second multiplexer between a first mode and a second mode with the sequence identifier based on whether the data sequence is the first data sequence or the second data sequence.

25. The method of claim 24 further comprising the step of receiving an output of the second multiplexer with an automatic gain control loop.

26. The method of claim 14 further comprising the step of controlling a loop bandwidth of the circuit with the sequence detector based on a timing stage of the data sequence that is determined by the sequence detector.

27. A circuit for a high-density data recording channel, the circuit comprising:
a 3-level slicer that generates a first data detector output;
a Viterbi detector that is adapted to generate a second data detector output;
an automatic gain control loop;
a phase-locked loop;
a first multiplexer that changes between a first mode and a second mode to alternately receive the first data detector output and the second data detector output, wherein an output of the first multiplexer proceeds to the automatic gain control loop;
a second multiplexer that changes between the first mode and the second mode to alternately receive the first data detector output and the second data detector output, wherein an output of the second multiplexer proceeds to the phase-locked loop; and
a sequence identifier that receives a data sequence including at least one of a VFO data sequence and a random data sequence that includes a greater number of signal levels than the VFO data sequence, the sequence identifier changing the first multiplexer between the first mode and the second mode and the second multiplexer between the first mode and the second mode based on whether the data sequence is the VFO data sequence or the random data sequence.

28. The circuit of claim 27 wherein the data sequence includes a plurality of timing stages, and the sequence detector at least partially controls a loop bandwidth of the circuit based on the timing stage of the data sequence.
